(19) United States
(12) Patent Application Publication
(10) Pub. No.: US 2013/0090019 A1
(43) Pub. Date: Apr. 11, 2013

(54) Electrical Connector

(71) Applicants: Yu-Hung Su, New Taipei (TW); Yao-Ting Wang, New Taipei (TW)

(72) Inventors: Yu-Hung Su, New Taipei (TW); Yao-Ting Wang, New Taipei (TW)

(73) Assignee: CHENG UEI PRECISION INDUSTRY CO., LTD., New Taipei City (TW)

(21) Appl. No.: 13/270,394

(22) Filed: Oct. 11, 2011

(51) Int. Cl. H01R 24/00

(52) U.S. Cl. 439/660

(57) ABSTRACT

An electrical connector includes a first connector which includes a first insulating body and first terminals disposed in the first insulating body with one end thereof being exposed outside for connecting with one external connector, a second connector which includes a second insulating body and second terminals disposed in the second insulating body with one end thereof being exposed outside for connecting with another different external connector, and a shell enclosing the first connector and the second connector and looped from a metal plate with a matching mouth being freely opened for the convenience of the insertion of the external connectors to connect with the first connector or the second connector, wherein the first connector and the second connector are connected together by molding the first insulating body and the second insulating body integrally in a single mold.

### BACKGROUND OF THE INVENTION

1. Field of the Invention

The present invention relates to an electrical connector, and more particularly to an electrical connector capable of connecting with various external connectors simultaneously.

2. The Related Art

With fast development of electronic technology, various electronic products and peripheral devices thereof are connected with each other with increasing frequency. So, an electrical connector, such as a USB connector and a HDMI connector etc., is often used to achieve the connection between the electronic products and the peripheral devices thereof. However, the electrical connector is generally capable of connecting just with one electronic product to transmit data information therethrough. When data transmission needs to be happened in some different kinds of electronic products simultaneously, corresponding different kinds of electrical connectors need to be carried in the same place. As a result, complicated take and use are caused. So, an electrical connector capable of overcoming the forgoing problems is required.

### SUMMARY OF THE INVENTION

An object of the present invention is to provide an electrical connector adapted to be connected with two kinds of different external connectors and a printed circuit board. The electrical connector includes a first connector which includes a first insulating body and a plurality of first terminals disposed in the first insulating body with one end thereof being exposed outside for electrically connecting with the corresponding external connector and the other end thereof being projected outward for being soldered to the printed circuit board, a second connector which includes a second insulating body and a plurality of second terminals disposed in the second insulating body with one end thereof being exposed outside for electrically connecting with another corresponding external connector and the other end thereof being projected outward for being soldered to the printed circuit board, and a shell enclosing the first connector and the second connector and looped from a metal plate with a matching mouth being freely opened for the convenience of the insertion of the external connectors to connect with the first connector or the second connector, wherein the first connector and the second connector are connected together by molding the first insulating body and the second insulating body integrally in a single mold.

As described above, the electrical connector includes the first connector, the second connector and the shell so as to electrically connect with different external connectors, so that realizes convenient take and use of the electrical connector.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with an embodiment of the present invention;

FIG. 2 is an exploded view of the electrical connector of FIG. 1; and

FIG. 3 is another angle of exploded view of the electrical connector of FIG. 1.

### DETAILED DESCRIPTION OF THE PREFERRED EMBODIMENT

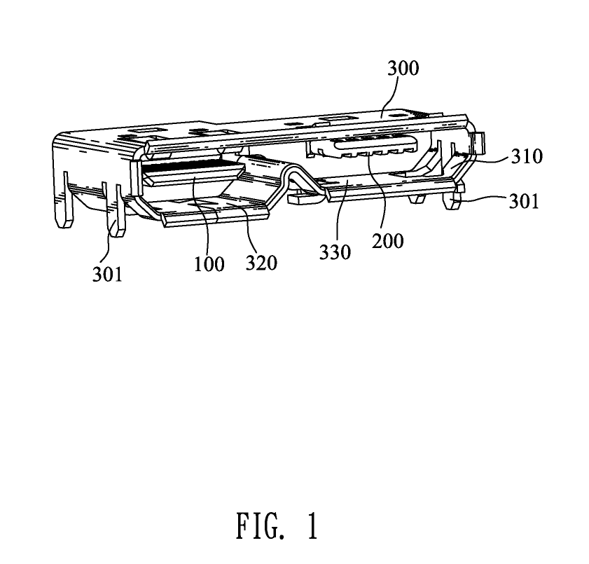

Referring to FIG. 1, an electrical connector in accordance with an embodiment of the present invention includes a first connector 100, a second connector 200 and a shell 300, wherein the first connector 100 and the second connector 200 are adapted to be connected with two kinds of different external connectors (not shown). Furthermore, the first connector 100 and the second connector 200 are connected together by being integrally molded in a single mold (not shown). The shell 30 encloses the first connector 100 and the second connector 200, and is looped from a metal plate to substantially show a rectangular cylindrical shape with a matching mouth 310 being freely opened for the convenience of the insertion of the external connectors to connect with the first connector 100 or the second connector 200.

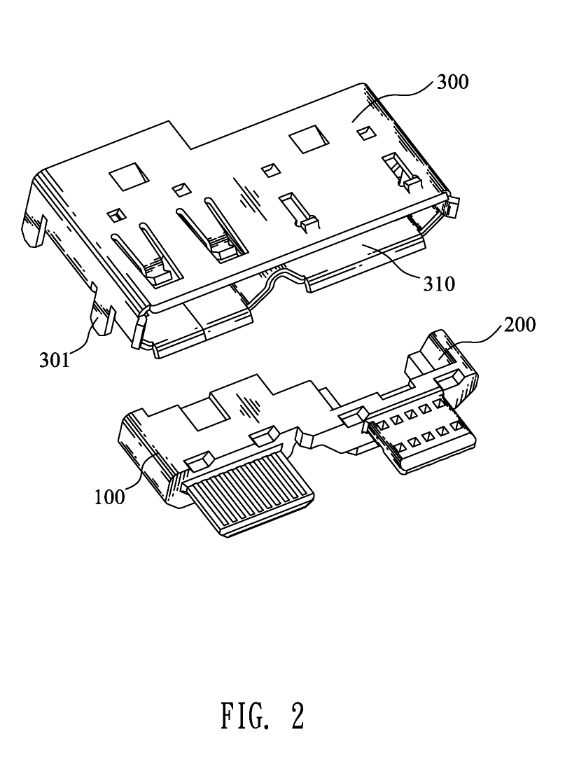

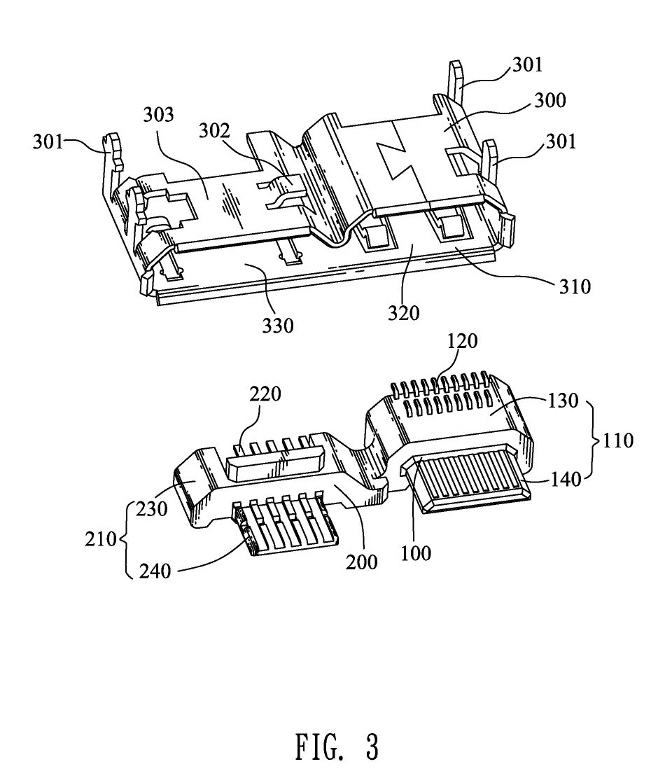

Referring to FIG. 2 and FIG. 3, the first connector 100 includes a first insulating body 110 which has a first base portion 130 and a first tongue portion 140 protruded forward from a front side of the first base portion 130 and spaced from insides of the shell 300, and a plurality of first terminals 120 which are disposed in the first insulating body 110 with one end thereof being exposed on the first tongue portion 140 for electrically connecting with the corresponding external connector, and the other end thereof being projected out of the first base portion 130 and the shell 300 to be soldered with a printed circuit board (not shown). The second connector 200 includes a second insulating body 210 which has a second base portion 230 and a second tongue portion 240 protruded forward from a front side of the second base portion 230 and spaced from insides of the shell 300, and a plurality of second terminals 220 which are disposed in the second insulating body 210 with one end thereof being exposed on the second tongue portion 240 for electrically connecting with the corresponding external connector, and the other end thereof being projected out of the second base portion 230 and the shell 300 to be soldered with the printed circuit board. The first connector 100 and the second connector 200 are connected together by being integrally molded in the single mold to make two sides of the first base portion 130 and the second base portion 230 connected together. In this embodiment, the first insulating body 110 and the second insulating body 210 are made of insulative material to ensure uninfluenced electrical performances between the first connector 100 and the second connector 200 even if the first base portion 130 and the second base portion 230 are connected together. In the embodiment, the first connector 100 is a HDMI connector and the second connector 200 is a USB connector, or the first connector 100 is a USB2.0 connector and the second connector 200 is a USB3.0 connector. In a word, the first connector 100 and the second connector 200 are two kinds of different connectors.

A first receiving chamber 320 and a second receiving chamber 330 are surrounded in the shell 300, and communicated with each other for respectively receiving the first connector 100 and the second connector 200 therein. The first receiving chamber 320 and the second receiving chamber 330 have front ends thereof further connected with two ends of the matching mouth 310 for the convenience of the insertion of the corresponding external connectors into the first receiving chamber 320 and the second receiving chamber 330 so as to electrically connect with the first connector 100 or the second connector 200. Two opposite sides of the shell 300 protrude downward to form a plurality of soldering tails 301 adapted for being soldered to the printed circuit board. In the embodiment, because the first base portion 130 of the first connector 100 has a thicker thickness than that of the second base portion 230 of the second connector 200, the first receiving chamber 320 and the second receiving chamber 330 are designed with different heights for meeting different demands of the first connector 100 and the second connector 200. As a result, the first receiving chamber 320 and the second receiving chamber 330 are not at the same level with respect to the printed circuit board. So, a bottom plate 303 of the second receiving chamber 330 is punched downward to form a resisting tail 302 designed at the same level with a bottom side of the first receiving chamber 320 to resist against the printed circuit board for propping the second receiving chamber 330 with the bottom side of the first receiving chamber 320 being against the printed circuit board so as to avoid a deformation of the shell 300 by long use.

As described above, the electrical connector includes the first connector 100, the second connector 200 and the shell 300 so as to electrically connect with different external connectors, so that realizes convenient take and use of the electrical connector.

What is claimed is:

1. An electrical connector adapted to be connected with two kinds of different external connectors and a printed circuit board, comprising:
a first connector including a first insulating body and a plurality of first terminals disposed in the first insulating body with one end thereof being exposed outside for electrically connecting with the corresponding external connector and the other end thereof being projected outward for being soldered to the printed circuit board;
a second connector including a second insulating body and a plurality of second terminals disposed in the second insulating body with one end thereof being exposed outside for electrically connecting with another corresponding external connector and the other end thereof being projected outward for being soldered to the printed circuit board; and
a shell enclosing the first connector and the second connector and looped from a metal plate with a matching mouth being freely opened for the convenience of the insertion of the external connectors to connect with the first connector or the second connector,
wherein the first connector and the second connector are connected together by molding the first insulating body and the second insulating body integrally in a single mold.

2. The electrical connector as claimed in claim 1, wherein the first connector and the second connector are two kinds of different connectors for connecting with the two kinds of different external connectors.

3. The electrical connector as claimed in claim 2, wherein the first connector is a HDMI connector and the second connector is a USB connector.

4. The electrical connector as claimed in claim 2, wherein a first receiving chamber and a second receiving chamber are surrounded in the shell, and communicated with each other for respectively receiving the first connector and the second connector therein, the first receiving chamber and the second receiving chamber have front ends thereof further connected with two ends of the matching mouth for the convenience of the insertion of the corresponding external connectors into the first receiving chamber and the second receiving chamber.

5. The electrical connector as claimed in claim 4, wherein the first receiving chamber and the second receiving chamber are designed with different heights for meeting different demands of the first connector and the second connector having different thicknesses, a bottom plate of the second receiving chamber is punched downward to form a resisting tail designed at the same level with a bottom side of the first receiving chamber to resist against the printed circuit board for propping the second receiving chamber with the bottom side of the first receiving chamber being against the printed circuit board.
